(19) United States
(12) Patent Application Publication
(10) Pub. No.: US 2025/0002311 A1
(43) Pub. Date: Jan. 2, 2025

(54) METHOD OF AND KIT FOR MOBILIZING PALLETS IN A HOSTILE ENVIRONMENT

(71) Applicant: Government of the United States as represented by the Secretary of the Air Force, Wright-Patterson AFB, OH (US)

(72) Inventor: Michael Sturtevant, APO, AP, GU (US)

(21) Appl. No.: 18/610,516

(22) Filed: Mar. 20, 2024

Related U.S. Application Data
(60) Provisional application No. 63/511,069, filed on Jun. 29, 2023.

(51) Int. Cl. B66F 7/02; B62B 3/00; B62B 3/16; B65G 67/00

(52) U.S. Cl. CPC B66F 7/02; B62B 3/008; B65G 67/00; B62B 3/16

(57) ABSTRACT

A kit and method for moving a pallet in a hostile environment without the need for a forklift. The kit includes four lifting devices and at least one wheeled trailer. The trailer has a bed that is preferably only a few inches off the ground. The lifting devices are spaced around the pallet and used to raise the pallet from the ground above the height of the bed of the trailer. The trailer, or a pair of trailers, is/are disposed under the pallet and the pallet lowered onto the bed of the trailer(s). The trailer(s) is/are then used for personnel to manually push or pull the pallet to a desired location. The lifting devices may be jacks placed on the ground or may be hoists disposed above ground in uprights.

### CROSS REFERENCE TO RELATED APPLICATION

This application claims priority to and the benefit of provisional application 63/511,069 filed Jun. 29, 2023.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to moving pallets, such as 463L master pallets, from an offload point on a runway to a point of use without a forklift or other powered equipment and more particularly to moving such 463L master pallets with a kit that requires less than a full pallet footprint during transport to the offload point.

### BACKGROUND OF THE INVENTION

Referring to FIG. 1, combat offload is designed to move supplies and equipment from a cargo aircraft 22 into an austere or hostile location that is being built or otherwise lacks the infrastructure to move pallets 20 of supplies and equipment from the aircraft 22 offload point 25 to a point of use 26. Offloads must move quickly and efficiently in a combat environment. Pallets 20 which are left on a runway are subject to sabotage or other hostile acts. Supplies and equipment which are needed for combat operations cannot be deployed unless the respective pallets 20 are rapidly transported to the point of use 26.

Pallets 20 of supplies and equipment (collectively referred to as cargo 21) are delivered to the hostile location by cargo aircraft 22 such as a Boeing C-17 or CH-47 or a Lockheed Martin C-130, C-27 C-17, C-9 or C-5. The pallets 20 are offloaded from the aircraft 22 onto the runway by a forklift 23. The aircraft 22 quickly departs to minimize vulnerability and continue the mission. There are three combat offload methods approved for use by the Air Force.

Combat Method A occurs by unlocking the pallets 20 of interest, lowering the back ramp of a plane, such as a C-17, revving the engines and releasing the brakes. The sudden lurch forward of the plane leaves the pallet(s) 20 behind due to the lack of momentum and relative velocity of the aircraft 22. Combat Method A is suitable for total pallet 20 weights of 1000 lbs. to 12000 lbs. and not containing fragile items.

Combat Offload Method B allows applies to any item not exceeding 1500 lbs. For this method, eight barrels are lined up with four on each side parallel to the back ramp of an aircraft 22 such as a C-130. The pallets 20 securing engine stand are chained to the tailgate of a truck which will help pull the equipment off the C-130 as it slowly taxis forward. As the equipment is carefully removed, an airman from each side slides a barrel underneath the corners of the pallet 20, creating a solid foundation. This process continues until all equipment is completely removed from the aircraft 22. This process must be synchronized, which demands constant communication from the loadmasters, driver and aircrew. The aircraft's 22 engines must remain running in order for the pilots to slowly taxi and release the equipment.

Combat Method C enabling a controlled offload of single or multiple pallets 20 as the situation dictates with minimal ramp/taxiway space and no external equipment or support is available, the pallets 20 have a high CoG or when there are fragile items. In Combat Method C offloaded test pallets 20 are disposed on a lowered cargo ramp of the aircraft 22, controlling the descent speed using a winch, or draft strap, allowing gravity to carry each pallet 20 until it cleared the ground loading ramps and is on the runway.

A requirement common to each of Combat Methods A, B and C is to move the pallets 20 from the offload point 25 on the runway to a point of use 26. The point of use 26 can be a site for unpacking, for further distribution and/or immediate consumption. A forklift 23 has long been used to shuttle pallets 20 from the offload point 25 to these locations where the pallets 20 will ultimately be used.

But the forklift 23 displaces 5 pallet 20 positions on the cargo aircraft 22 and the supporting pallet 20 [tools, fuel] displaces a sixth pallet 20 position. Six pallets 20 of supplies and equipment are sacrificed. And attendant costs, personnel time and safety considerations are incurred to put the forklift 23 into operation.

Particularly, once the forklift 23 arrives at the hostile site at least 95 manhours are required for assembly and qualification of the forklift 23. Only then can the pallets 20 be maneuvered to new locations for use.

Accordingly, it is an object of this invention to overcome the problem of requiring plural pallet 20 positions on a cargo aircraft 22 for a single forklift 23-which has only the limited and dedicated functionality of removing pallets 20 from an offload position. It is further an object of this invention to provide a method for maneuvering pallets 20 in hostile environments without the need for electricity or fuel.

### SUMMARY OF THE INVENTION

In one embodiment the invention comprises a method of deploying a pallet from an offload point to a point of use. The method comprising the steps of: identifying a 463L master pallet to be moved from an offload point and circumscribed by a rail and having at least four spaced apart tie down rings; b) providing a kit comprising four uprights and four respective complementary lifting devices therefor, the uprights and lifting devices being configured together to raise a 463L master pallet loaded with cargo weighing not more than 10,000 lbs. from the ground to an elevation of at least 15 inches above the ground under manual power without an external power source, and at least one trailer configured to support the 463L master pallet when loaded with cargo weighing not more than 10,000 lbs., the trailer having a plurality of axially rotatable wheels supporting a bed thereon, the bed having an elevation above the ground of 4 inches to 25 inches; juxtaposing the four complementary lifting devices with four spaced apart tie down rings; securing or having secured a connector or lip between each lift and a respective tie down ring or rail, respectively; using the lifting devices together to lift the identified 463L master pallet above the ground to a height sufficient to dispose the trailer thereunder; disposing at least one trailer under the identified 463L master pallet; using the lifts together to lower the identified 463L master pallet onto the bed of the trailer; releasing the connectors from the respective tie down rings; and moving the trailer and the pallet thereon from the offload point to a point of use remote, wherein steps a and b are performed in any order and step c and d are performed in any order. In another embodiment the invention comprises the aforementioned kit.

### BRIEF DESCRIPTION OF THE DRAWINGS

FIG. 1 is a scale perspective view of a pallet unloading process for a CH-47 Helicopter according to the prior art, showing an offload point and point of use not to scale.

FIG. 2A is a scale perspective view of a 463L master pallet usable with the present invention.

FIG. 2B is a scale perspective view of two married 463L master pallets usable with the present invention.

FIG. 2C is a fragmentary scale perspective view of a rail of a 463L master pallet.

FIG. 3A is a schematic side elevational view of a kit according to the present invention.

FIG. 3B is a schematic top plan view of the kit of FIG. 3A being deployed on a 463L master pallet and two trailers shown in phantom, the cargo being omitted for clarity.

FIG. 4 is a scale side elevational view of a tripod hoist usable with the present invention.

FIG. 5 is a scale perspective view of a trailer usable with the present invention.

FIG. 6 is a perspective view of a pair of gantry cranes comprising four gantry crane uprights.

FIG. 7 is a scale perspective view of a gantry crane disassembled for shipping and storage.

FIG. 8 is a scale perspective view of a farm jack.

FIG. 9 is a scale profile view of a scissor jack.

FIG. 10 is a scale perspective view of a hydraulic hack.

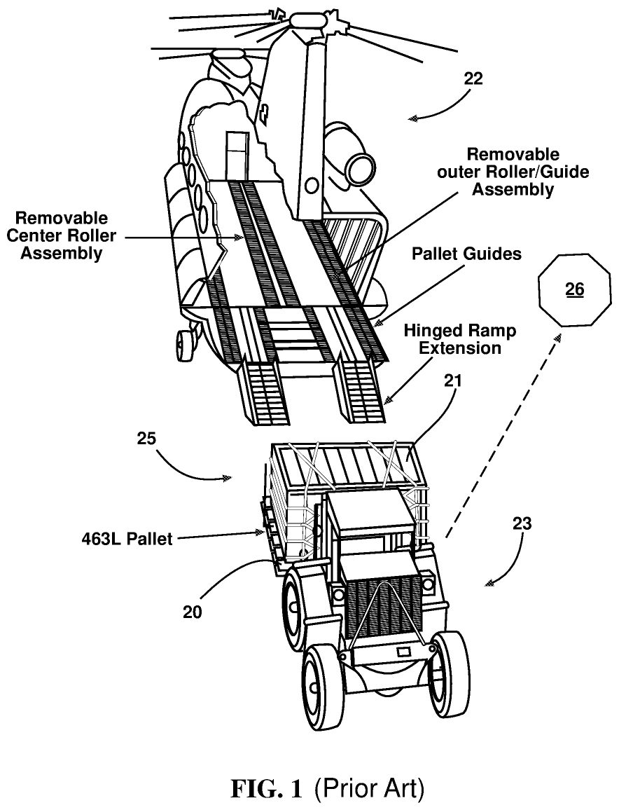

### DETAILED DESCRIPTION OF THE INVENTION

In one embodiment the invention comprises a kit 30 for moving pallets 20 in a hostile or austere environment. In such an environment, fuel and electricity may be scarce or completely unavailable. But there are typically military personnel ready and able to move the pallets 20 without requiring a forklift 23 as has typically occurred in the past. In the absence of a forklift 23 it is infeasible for personnel to try to manually move such a pallet 20, or a plurality of such pallets 20, without assistance such as provided by the invention described and claimed herein.

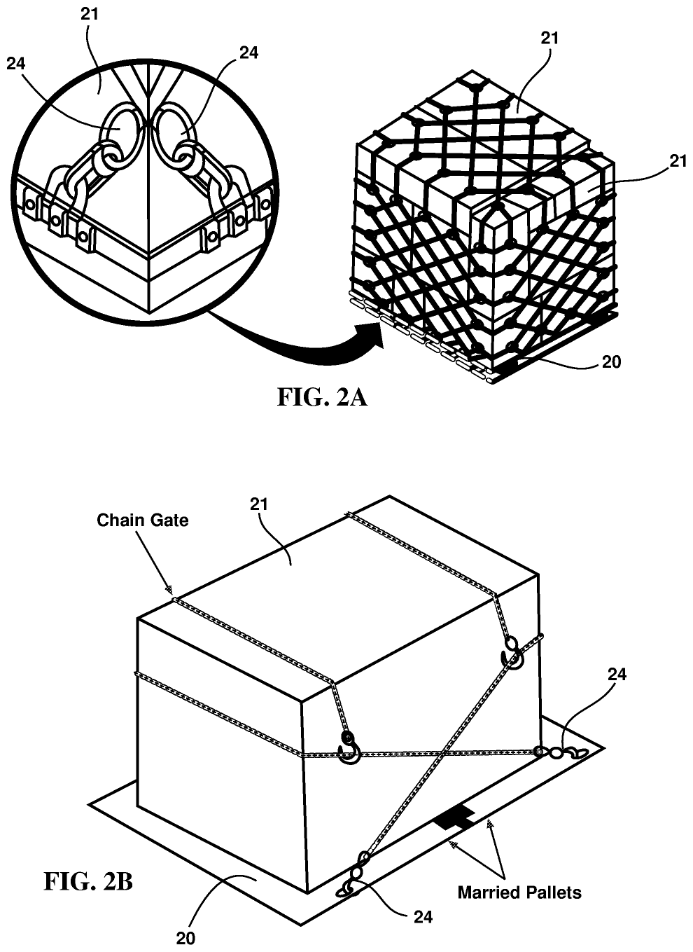

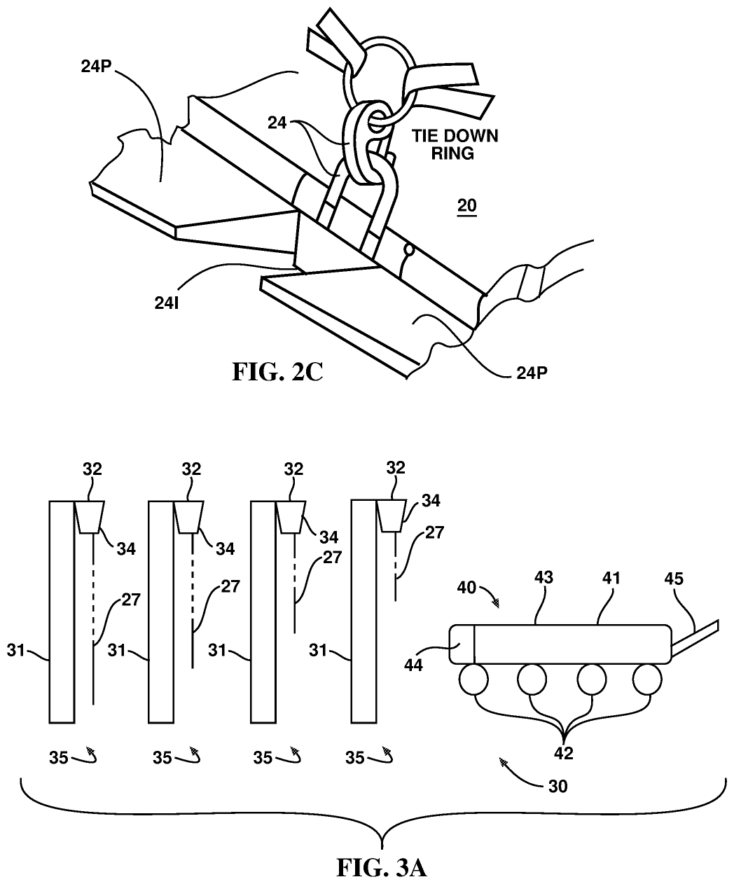

Referring to FIG. 2A, FIG. 2B and FIG. 2C, standardized pallets 20 include the 463L master pallet 20 developed in 1959 by the Douglas Aircraft Company and contracted to AAR Cadillac Manufacturing Corporation for manufacturing. The master pallet 20 (also known as a HCU-6/E pallet 20) complies with MIL-STD-1791 and can be turned sideways to fit on the rollers of C-130 and C-141 aircraft 22 and can be turned lengthwise to fit on the bed of a truck. Such pallets 20 are inventoried at four DoD Pallet and Net Distribution Centers per Defense Transportation Regulation—Part VI, Chapter 608 (19 Jan. 2023), incorporated herein by reference. Chapter 608.G.1 prohibits the use of 463L pallets 20 for any purpose other than pre-palletizing and transporting cargo 21 for airlift. Aircraft 22 pallet 20 capacities range from 6 pallets 20 in a C-130 to 35 pallets 20 in a C-5.

The 463L master pallet 20 is rectangular, 88 inches (220 cm) wide, 108 inches (270 cm) long, and 2¼ inches (5.7 cm) high. The usable space is 84 by 104 in (210 by 260 cm) with 2 inches (5 cm) per side to secure the straps, nets, or chains. The 463L master pallet 20 has an aluminum rail 24P on all four sides, encasing a balsa wood core. A large 463L pallet 20 can hold up to 10,000 lbs. (4,500 kg) of cargo 21, not exceeding 250 lbs. per square inch (17 kg per square cm). Empty, each pallet 20 weighs 290 pounds (130 kg) or 355 pounds (160 kg) with two side nets and a top net. The pallet 20 has 22 tie down rings 24 and registered indents 241 for use with one or more nets or connector 27s. The tie down rings 24/indents 241 are disposed with 5 spaced apart tie down rings 24/indents 241 on each of the shorter side and 6 spaced apart tie down rings 24/indents 241 on each of the longer sides. Each tie down ring 24 has a capacity of 7500 lbs (3400 kg). Based on the HCU-6/E air cargo 21 master pallet 20, additional components can include the HCU-7/E side net, the HCU-15/C top net, and the CGU-1/B Device or cargo 21 strap. MB-1 Devices or MB-2 Devices may be used with appropriate chains. The pallet 20 may be covered with a plastic 463L pallet 20 cover, NSN 3990-00-930-1480. The pallet 20 and cargo 21 form no part of the claimed invention except as may be specifically claimed below.

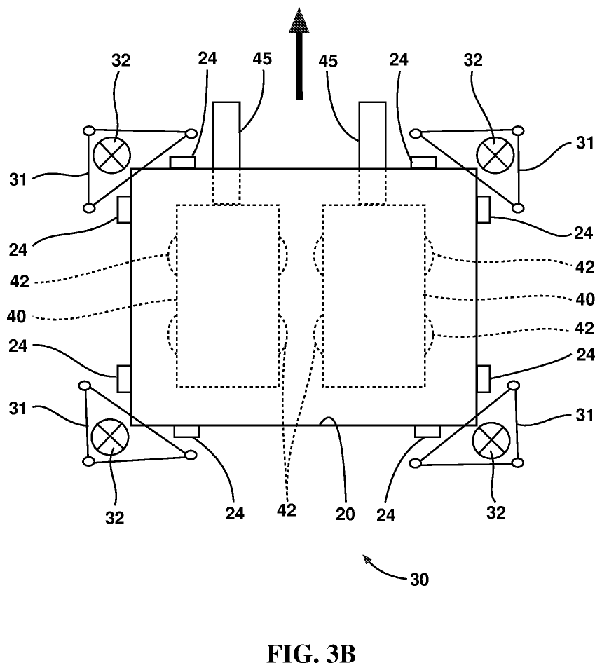

Referring to FIG. 3, in one embodiment the invention comprises a kit 30 for moving pallets 20 in a hostile environment without the need for external power such as electricity or fuel. The kit 30 comprises at least three uprights 31, preferably four uprights 31, a lifting device 32 for each upright 31 and a trailer 40. While four uprights 31 are preferred, one of skill will understand certain circumstances such as unsteady ground or unbalanced loads may call for additional uprights 31. In use one upright 31 may be juxtaposed with each corner of the pallet 20. The uprights 31 may be mutually different or, preferably, are mutually identical.

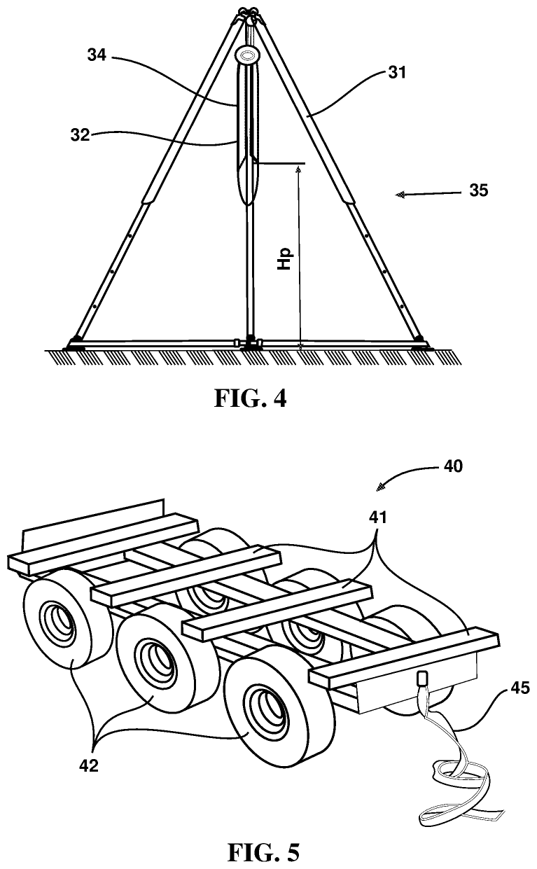

Referring to FIG. 4, in a preferred embodiment each upright 31 may comprise a tripod 33 and chain hoist 34 lifting device 32 paired together, collectively referred to as a tripod crane 35. The tripod 33 has individual uprights 31 connected at a peak. The tripod 33 and hoist 34 may be permanently or removably joined together. The tripod crane 35 may have an effective height Hp taken as the elevation above ground level of where the hoist 34 has a hook or other attachment for the pallet 20 of 1 foot to 3 feet [0.3 M to 0.9 M]. The tripod crane 35 should have a capacity of at least 3000 lbs. [1400 kg], 4000 lbs. [1800 kg] or 5000 lbs. [2300 kg]. Aluminum is preferred for its strength to weight ratio. An industrial tripod 33 crane available from Spanco, Inc. of Morgantown, PA has been found suitable.

Tripods 33 provide the benefit of having three legs fixedly joined at the top and being collapsibly separable at the bottom to widen the base. The legs can be collapsed for shipping/storage and then separated for use. Preferably the legs are telescoping to further conserve space during shipping/storage and to accommodate uneven ground during use.

For the lifting device 32, the chain hoist 34 is attached to the underside of the top of the tripod 33 at the confluence of the legs and hangs downwardly therefrom. The hoist 34 may be electrically powered or, preferably, is manually powered with a pull chain for use in austere locations not having electric power. By ‘manually powered’ it is meant that only human effort is used and external power sources such as motors and engines are not used. Manual power may include cams, pulleys, levers, handles, etc. The present embodiment has the benefit that the lifting device 32 is not on the ground and therefore avoids mud, debris, etc.

The hoist 34 may use chains as is common or may use straps to conserve weight, collectively referred to herein as connectors 27. The hoist 34 should have a length sufficient to extend from the confluence of the tripod 33 to the tie down rings 24 of the pallet 20. The hoist 34 should have a lift of 10 inches to 20 inches (25 cm to 50 cm) and preferably 12 inches to 15 inches (30 cm to 38 cm). A model CF hoist 34 having at least a two ton [1800 kg] capacity available from Harrington Hoists, Inc of Manheim, PA has been found suitable.

Referring to FIG. 5, the trailer 40 preferably has a capacity of at least 11000 lbs. [5000 kg], 12000 lbs. [5400 kg] or 13000 lbs. [5900 kg]. The trailer 40 has a bed 41 supported by a plurality of wheels 42 as necessary to accommodate the pallet 20 weight and roll under the applied weight of a fully loaded pallet 20. The wheels 42 may include pneumatic tires for cushioning and preventing obstruction by minor debris.

Optionally the trailer 40 may have a top surface 43 as shown or a tow bar (not illustrated) for attachment to a vehicle present at the unload location for other uses and not limited to or dedicated to the singular unloading task. Alternatively or additionally the trailer 40 may have an upstanding (not shown) for manual pushing or pulling by onsite personnel.

The trailer 40 preferably has a flat bed 41 with a high friction upwardly facing top surface 43. The top surface 43 receives the pallet 20 thereon and such a surface is helpful to prevent slippage and potential loss of the pallet 20 during transport from the offload location to the point of use 26.

The top surface 43 of the bed 41 of the trailer 40 has a height of 4 inches to 25 inches (10 cm to 635 cm) and preferably 6 inches to 10 inches (15 cm to 25 cm) and preferably not more than 8 inches (20 cm) to minimize the lift necessary by the uprights 31. Also a relatively lower height, such as 8 inches (20 cm) or less increases safety during transport and increases safety while decreasing effort during unloading at the point of use 26.

Preferably the trailer(s) 40 are manually moved by on site personnel. This procedure beneficially relies only upon people already at the site conducting the mission. Alternatively, the trailer(s) 40 may be powered by a DC battery and associated drive mechanism 44. This configuration reduces the number of personnel needed to transport the pallet 20 from the unload site to the point of use 26. And the battery(ies) may be pulled from the trailer(s) 40 and used in other complementary DC tools and equipment. But optional the battery (ies)/drive mechanism combination 44 add weight and maintenance to the kit 30.

In a preferred embodiment the kit 30 has a plurality of mutually identical trailers 40. For example, each trailer 40 may have a bed 41 with dual platforms of 2.5 feet to 4 feet [0.8 M to 1.2 M] wide×6 feet to 10 feet [1.8 M to 3 M] long and preferably 3 feet wide by 8 feet long [0.9 M wide by 2.4 M long]. Or the bed 41 may have a single platform 5 feet to 9 feet [1.5 M to 2.7 M] wide and preferably 7 feet [2.1 M] wide, by 6 feet to 10 feet [1.8M to 3 M] long and preferably 8 feet [2.4 M] long. The pair of trailers 40 provides the benefit that each trailer 40 may support half of the pallet 20 load and the trailers 40 may be stacked during transport to further conserve footprint during shipping/storage. Furthermore, it is easier to build in redundancy by having three smaller trailers 40 than two bigger trailers 40 in the event a trailer 40 needs maintenance or fails during service.

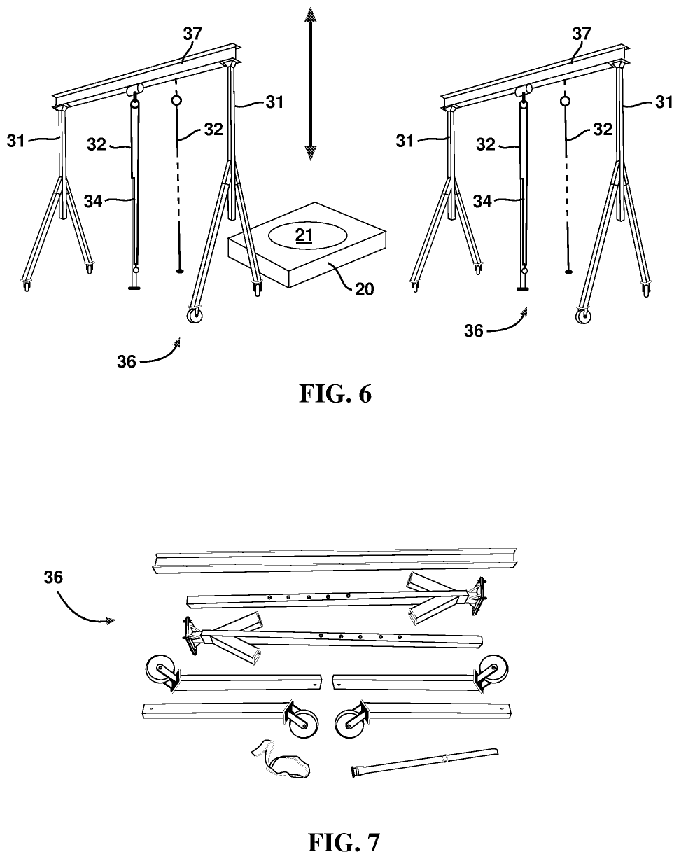

Referring to FIG. 6 and to FIG. 7, in an alternative embodiment the four uprights 31 may comprise a pair of gantry cranes 36. Each gantry crane 36 has a respective pair of uprights 31 joined by an overhead beam. A suitable lifting device 32, such as the aforementioned hoist 34, is joined to the overhead beam. Preferably two lifting devices 32 are joined to the overhead beam. The lifting device(s) 32 may be joined to the beam using a trolley 37. This arrangement provides the benefit of flexibility for the hoists 34 to be moved back and forth along the overhead beam in order to be juxtaposed with heavier areas of the pallet 20 for stability. The gantry crane 36 may be disassembled for shipping and storage.

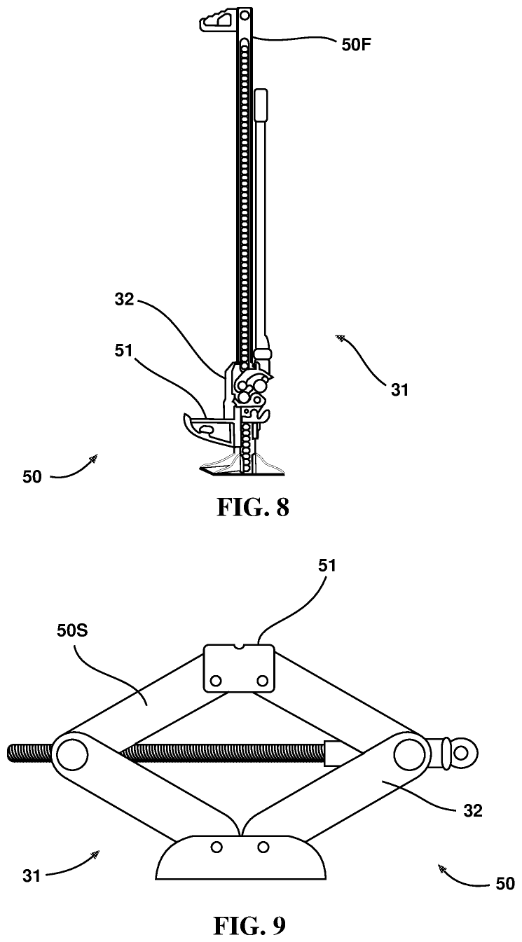

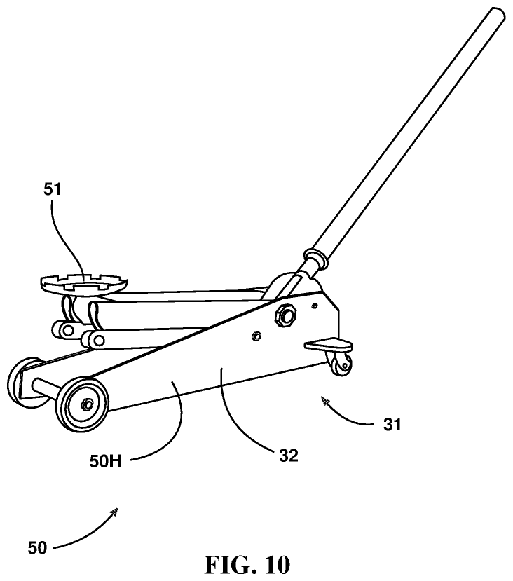

Referring to FIG. 8, FIG. 9 and FIG. 10 in an alternative embodiment the upright 31 and lifting device 32 may be combined into a unitary fixture. In such an embodiment the lifting device 32 may be disposed at ground level, obviating the need for connectors 27 to suspend the pallet 20 above trailer 40. This embodiment uses at least three jacks 50, and preferably four, jacks 50 for the lifting device 32, with at least one lifting device 32 juxtaposed with each corner of the pallet 20, as described above. The jacks 50 may be mutually different or, preferably, are mutually identical. This embodiment has the benefit that the lifting devices 32 are on the ground, thereby lowering the center of gravity and inherently accommodating uneven ground. A farm jack 50F has the benefit an elongate form factor and greater lift from the ground than other comparable jacks 50. A scissors jack 50S has the benefit of collapsing to a compact footprint. A hydraulic jack 50H has the benefit of greater load capacity than other comparable jacks 50. Mutually different jacks 50 provide the benefit that different jacks 50 can be used for different corners/sides of the pallet 20 as needed.

The lip 51 of the respective jack 50 is placed under or within the space of the pallet 20 desired to be lifted. When the preferably at least four jacks 50 are in place, the jacks 50 are activated so that the pallet 20 is raised in a level manner and the cargo 21 is not spilled or disrupted. When the pallet 20 is at a sufficient elevation for the trailer 40 to be disposed under the pallet 20, the trailer(s) 40 is/are moved under the pallet 20 and the pallet 20 is lowered onto the trailer 40 for transport to the point of use 26. The pallet 20 is lowered using the four lifts in unison to prevent spillage or a safety hazard.

The kit 30 described and claimed herein can be made for less than $20,000, less than one-third the cost of a 10K forklift 23. Furthermore the kit 30 requires less than 1 pallet 20 footprint. A typical 10K forklift 23 used according to the prior art weighs more than 12 tons (13,600 kg), requires explosive fuel and displaces six positions of pallets 20. The kit 30 according to the present invention weighs less than 2500 lbs. [1100 kg] and does not require storage or handing of associated hazardous materials.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern. All limits shown herein as defining a range may be used with any other limit defining a range of that same parameter. That is the upper limit of one range may be used with the lower limit of another range, and vice versa. As used herein, when two components are joined or connected the components may be interchangeably contiguously joined together or connected with an intervening element therebetween. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A kit for moving 463L master pallets from an offload point without the use of powered equipment, the kit comprising:
four uprights, four respective complementary lifting devices therefor and four strap suitable for removably attaching a lifting device to a complementary tie down ring on the 463L master pallet, the uprights and lifting devices being configured to raise a 463L master pallet loaded with cargo weighing not more than 10,000 lbs. from the ground to an elevation of at least 15 inches above the ground under manual power without an external power source, and
a first trailer configured to support the 463L master pallet loaded with cargo weighing not more than 10,000 lbs., the trailer having a plurality of axially rotatable wheels supporting a bed thereon, the bed having an elevation above the ground of 4 inches to 25 inches.

2. A kit according to claim 1 wherein the four respective complementary lifting devices are attached to the uprights at a position corresponding to the top of respective uprights.

3. A kit according to claim 3 wherein each upright is a tripod having telescoping legs.

4. A kit according to claim 3 wherein the four uprights comprise a pair of gantry cranes, each gantry crane having a respective pair of uprights joined by an overhead beam.

5. A kit according to claim 3 wherein each of the complementary lifting devices comprises a chain hoist.

6. A kit according to claim 4 wherein each of the complementary lifting devices comprises a chain hoist disposed on a trolley.

7. A kit according to claim 1 further comprising a second trailer substantially identical to the first trailer.

8. A kit for moving 463L master pallets from an offload point without the use of powered equipment, the kit comprising:
four uprights and four respective complementary jacks therefor, the uprights and four respective complementary jacks being configured to raise a 463L master pallet loaded with cargo weighing not more than 10,000 lbs. from the ground to an elevation of at least 15 inches above the ground under manual power without an external power source, and
at least one trailer configured to support the 463L master pallet loaded with cargo weighing not more than 10,000 lbs., the trailer having a plurality of axially rotatable wheels supporting a bed thereon, the bed having an elevation above the ground of 4 inches to 25 inches.

9. A kit according to claim 8 wherein the four respective complementary jacks are mutually identical.

10. A kit according to claim 9 wherein the four respective complementary jacks are selected from the group consisting of a farm jack and scissors jack.

11. A kit according to claim 10 wherein each of the four respective complementary jacks has a lifting capacity of at least 3000 lbs.

12. A method of deploying a 463L master pallet from an offload point to a point of use, the method comprising the steps of:
a) identifying a 463L master pallet to be moved from an offload point and circumscribed by a rail and having at least four spaced apart tie down rings;
b) providing a kit comprising four uprights and four respective complementary lifting devices therefor, the uprights and lifting devices being configured together to raise a 463L master pallet loaded with cargo weighing not more than 10,000 lbs. from the ground to an elevation of at least 15 inches above the ground under manual power without an external power source, and
at least one trailer configured to support the 463L master pallet when loaded with cargo weighing not more than 10,000 lbs., the trailer having a plurality of axially rotatable wheels supporting a bed thereon, the bed having an elevation above the ground of 4 inches to 25 inches;
c) juxtaposing the four complementary lifting devices with four spaced apart tie down rings;
d) securing or having secured a connector or lip between each lift and a respective tie down ring or rail, respectively;
e) using the lifting devices together to lift the identified 463L master pallet above the ground to a height sufficient to dispose the trailer thereunder;
f) disposing at least one trailer under the identified 463L master pallet;
g) using the lifts together to lower the identified 463L master pallet onto the bed of the trailer;
h) releasing the connectors from the respective tie down rings; and
i) moving the trailer and the pallet thereon from the offload point to a point of use remote, wherein steps a and b are performed in any order and step c and d are performed in any order.

13. A method according to claim 12 further comprising the steps of collecting the components of the kit and moving the kit to the point of use.

14. A method according to claim 13 further comprising the step of identifying a second 463L master pallet to be moved from the offload point and repeating steps c through h.

15. A method according to claim 14 wherein the second pallet is moved to the same point of use as the original pallet.

16. A method according to claim 12 wherein the 463L master pallet has a rail on each side thereof, the four respective complementary lifting devices each comprise a jack and the step of lifting the 463L master pallet comprises placing the lip of a jack under a portion of the rail and lifting the pallet using the four jacks.

17. A method according to claim 16 further comprising the step of placing a second trailer under the pallet while it is lifted from the ground and lowering the pallet onto the first trailer and second trailer and using both trailers to move the pallet to the point of use, the two trailers being substantially mutually identical.

18. A method according to claim 12 wherein the four respective complementary lifting devices each comprises a tripod and associated hoist and the step of lifting the 463L master pallet comprises attaching a connecter between each hoist and a complementary tie down ring and lifting the pallet using the four hoists.

19. A method according to claim 18 wherein each tripod comprises three telescoping legs and further comprising the step of adjusting each leg of the four tripods to accommodate uneven ground.

20. A method according to claim 12 wherein the four respective complementary lifting devices comprises a pair of gantry cranes connected by a trolley.
